(19) United States
(12) Patent Application Publication
(10) Pub. No.: US 2005/0094960 A1
(43) Pub. Date: May 5, 2005

(54) Optical attenuator

(76) Inventors: Jung Hyun Lee, Suwon (KR); Yoon Shik Hong, Sungnam (KR); Jong Sam Kim, Suwon (KR)

Correspondence Address: LOWE HAUPTMAN GILMAN & BERNER, LLP, Suite 310, 1700 Diagonal Road, Alexandria, VA, 22314, US

(21) Appl. No.: 10/790,022

(22) Filed: Mar. 2, 2004

(30) Foreign Application Priority Data
Oct. 29, 2003 (KR) 2003-75842

(51) Int. Cl. G02B 6/00

(52) U.S. Cl. 385/140

(57) ABSTRACT

An optical attenuator includes an attenuating section arranged between a receiving waveguide coaxial with a receiving optical fiber and a transmitting waveguide coaxial with a transmitting optical fiber to attenuate the intensity of light emitted from the receiving waveguide. In the optical attenuator, an actuator drives a movable section across the propagation of light. An inner housing has a cover mounted with the receiving and transmitting waveguides in an underside and a body arranged and bonded under the cover. The receiving and transmitting waveguides can be arranged in a cavity of the body without interference. An outer housing contains the inner housing to protect the same. A calibrating section generates attractive force from above the cover to pull the movable section against the latitudinal deformation thereof so that optical axes of the attenuating section and the receiving and transmitting sections are coaxially aligned, compensating the vertical deformation of the movable section, in order to minimize the initial insertion loss of light as well as improve optical properties of a final product.

### BACKGROUND OF THE INVENTION

1. Field of the Invention

The present invention relates to an optical attenuator capable of compensating the vertical deformation of a movable section of an actuator owing to the internal stress of a cover through application of magnetic force in order to minimize the initial insertion loss of light as well as improve optical properties of a final product.

2. Description of the Related Art

Recently, thanks to increasing interest to fiber optic communication systems, technologies related with optical communication instruments or devices widely used in communication networks are under active development.

An optical attenuator functioning as one of optical communication devices attenuates the intensity of incident light to a predetermined level before emission. Optical attenuators like this are used for optical communication devices having different light transmittances. For example, when a Wavelength Division Multiplexing (WDM) system uses optical signals of several different wavelengths, the WDM system is so designed to use the same intensity of optical signals, whereas lasers as light sources generate optical signals of different intensities. Thus, the optical attenuators are used to calibrate the different intensities of optical signals.

Such optical attenuators are classified into a fixed optical attenuator having a fixed attenuating level and a variable optical attenuator capable of variably attenuating light.

The optical attenuators are also required to equalize different light transmittances of channels in Multiplexers (MUX) and Demultiplexers (DeMUX) of a WDM system or optical switches. In this case, variable optical attenuators having variable optical transmittances instead of fixed values are required because optical loss may be varied according to optical paths.

FIG. 1 is a perspective view of a general optical attenuator, FIG. 2A is a plan view of the general optical attenuator shown in FIG. 1, and FIG. 2B is a sectional view taken along a line A-A′ in FIG. 2A.

As shown in FIGS. 1 to 2B, a variable optical attenuator 1 includes a receiving optical fiber 2 for receiving light, a receiving waveguide 3 for guiding light introduced through the receiving optical fiber 2, an attenuating section 4 operated to an offset position to attenuate the intensity of light received from the receiving waveguide 3, a transmitting waveguide 5 for guiding attenuated light from the attenuating section 4, a transmitting optical fiber 6 for emitting light transmitted from the transmitting waveguide 5, an actuator 7 for driving the attenuating section 4 and a cover 8 overlying the above components. The cover 8 is assembled with a body 9 into a box-like structure, in which the body 9 has a cavity 9a allowing the receiving and transmitting waveguides 3 and 5 to be arranged without interference.

The actuator 7 includes a drive section 7b fixed in position to the cover 8 and a movable section 7a arranged movable with respect to the drive section 7b and having the attenuating section 4 attached thereto.

FIGS. 3A to 3C illustrate the operation of the general optical attenuator shown in FIG. 1. As shown in FIGS. 3A to 3C, the operation of attenuating light intensity is carried out by shifting the attenuating section 4 which is arranged between the receiving waveguide 3 connected to the receiving optical fiber 2 and the transmitting waveguide 5 connected to the transmitting optical fiber 6.

The light intensity-attenuating operation is carried out by the actuator 7. The actuator 7 drives the movable section 7a mounted with the attenuating section 4 to offset forward/backward to a predetermined length or angularly to a predetermined angle with respect to the drive section 7b fixed to the plate 8 in order to adjust the quantity of light propagating through the attenuating section 4. In this way, the intensity of light propagating from the receiving optical fiber 2 to the transmitting optical fiber 6 can be controlled precisely.

In the optical attenuator 1 as above, it is essential for the attenuating section 4 to be aligned coaxial with both the receiving and transmitting waveguides 3 and 5 to attenuate light propagating therebetween without insertion loss.

However, the optical attenuator 1 has an internal structural problem that the movable section 7a is vertically deformed or sags downward about the cover 8 mounted with the receiving and transmitting waveguides 3 and 5 so that a height difference h occurs between the movable section 7a and the receiving and transmitting waveguides 3 and 5. This misaligns the optical axis increasing the insertion loss of light thereby to deteriorate optical properties of products.

This takes place because the movable section 7a holding the attenuating section 4 is supported by elastic members 7c of the cover 8 so that the attenuating section 4 can be moved with respect to the drive section 7b of the actuator 7, whereas both the receiving and transmitting waveguides 3 and 5 are mounted on the cover 8 maintaining stable vertical position.

The vertical deformation of the movable section 7a can be also induced from residual stress in the cover 8, which is created during forming the receiving and transmitting waveguides 3 and 5 on the cover 8, bonding the cover 8 to the body 9 or grinding the cover 8 to reduce its thickness.

As conventional approaches to solve the above problem, the actuator 7 has been designed in a structure capable of minimizing the internal residual stress of the movable section 7a occurring in fabrication of the optical attenuator 1 or the actuator 7 has been annealed additionally after fabrication thereof to remove the internal residual stress.

However, there are problems that the change of design for modifying the structure of the actuator 7 is not easy, the internal residual stress is not completely removed, and addition of annealing complicates the fabrication process of the actuator while increasing the fabrication cost thereof.

### SUMMARY OF THE INVENTION

The present invention has been made to solve the foregoing problems of the prior art.

It is an object of the present invention to provide an optical attenuator which can compensate the vertical deformation of an actuator causing the height difference between a drive section and a movable section to minimize initial insertion loss thereby improving optical properties of a final product.

According to an aspect of the invention for realizing the object, there is provided an optical attenuator which includes an attenuating section arranged between a receiving waveguide coaxial with a receiving optical fiber and a transmitting waveguide coaxial with a transmitting optical fiber to attenuate the intensity of light emitted from the receiving waveguide to the transmitting waveguide, comprising: an actuator for driving a movable section across the propagation of light, the attenuating section being arranged in the movable section; an inner housing including a cover mounted with the receiving and transmitting waveguides in an underside thereof and a body arranged and bonded under the cover, the body having a cavity allowing the receiving and transmitting waveguides to be arranged without interference; an outer housing containing and surrounding the inner housing to protect the same; and a calibrating section for generating attractive force from above the cover to pull the movable section against the latitudinal deformation thereof so that optical axes of the attenuating section and the receiving and transmitting sections are coaxially aligned.

It is preferred that the calibrating section includes a thin metal layer formed in an upper face of the cover and a magnet member supported by the outer housing to generate magnetic force for pulling the thin metal layer upward.

It is preferred that the thin metal layer is a pattern printed on the upper face of the cover.

It is preferred that the metal thin layer is made of a ferromagnetic material such as Ni and NiFe.

The optical attenuator may further comprise an anti-oxidation protective layer coated on the upper face of the thin metal layer.

It is preferred that the protective layer is made of one selected from a group including Ti, Cr, Al, Au and mixtures thereof.

It is preferred that the metal thin layer is an upper electrode connected with an output terminal of the main board via a wire member using a wire bonding technique.

It is preferred that the magnet member is a permanent magnet for generating magnetic force toward the cover.

It is preferred that the permanent magnet includes an adjustment section for shifting the permanent magnet upward or downward to vary the gap between the cover and the permanent magnet, and wherein the adjustment section includes a predetermined length of a screw for precision adjustment, the screw being meshed into a threaded hole of the outer housing and mounted with the permanent magnet on a leading end thereof, and a control knob arranged in a rear end of the screw.

It is preferred that the magnet member is an electromagnet capable of varying magnetic force to the cover.

It is preferred that the electromagnet includes a power supply electrically connected with power-supplying wires, and wherein the power supply has a control knob for adjusting the quantity of electric power supplied to the wire to vary the strength of magnetic force.

It is preferred that the calibrating section includes a permanent magnet layer formed on the upper face of the cover to generate a predetermined strength of magnetic force and a metal member supported by the outer housing to pull the permanent magnet layer upward.

It is preferred that the permanent magnet layer is a pattern printed on the upper face of the cover at a predetermined thickness.

It is preferred that the metal member is made of a ferromagnetic material such as Ni and NiFe.

The optical attenuator may further comprise an anti-oxidation protective layer coated on the upper face of the thin metal layer.

It is preferred that the protective layer is made of one selected from a group including Ti, Cr, Al, Au and mixtures thereof.

It is preferred that the permanent magnet layer is an upper electrode connected with an output terminal of the main board via a wire member using a wire bonding technique.

It is preferred that the metal member includes an adjustment section for shifting the metal member upward or downward to vary the gap between the permanent magnet layer and the permanent magnet, and wherein the adjustment section includes a predetermined length of a screw for precision adjustment, the screw being meshed into a threaded hole of the outer housing and mounted with the metal member on a leading end thereof, and a control knob arranged in a rear end of the screw.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a general optical attenuator;

FIG. 2A is a plan view of the general optical attenuator shown in FIG. 1;

FIG. 2B is a sectional view taken along a line A-A′ in FIG. 2A;

FIGS. 3A to 3C illustrate the operation of the general optical attenuator shown in FIG. 1;

FIG. 4 is a perspective view of an optical attenuator according to a preferred embodiment of the invention;

FIG. 5 is a sectional view illustrating the construction of the optical attenuator shown in FIG. 4;

FIG. 6 is a sectional view illustrating the construction of an optical attenuator according to an alternative embodiment of the invention; and

FIGS. 7A to 7H illustrate process steps of fabricating a plate unit utilized in an optical attenuator of the invention.

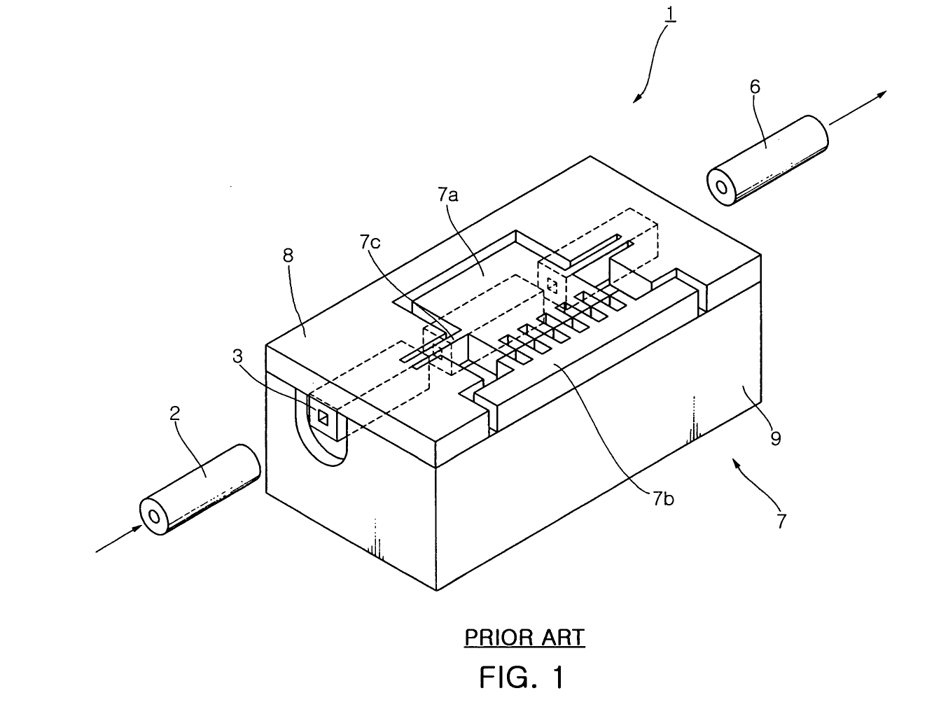

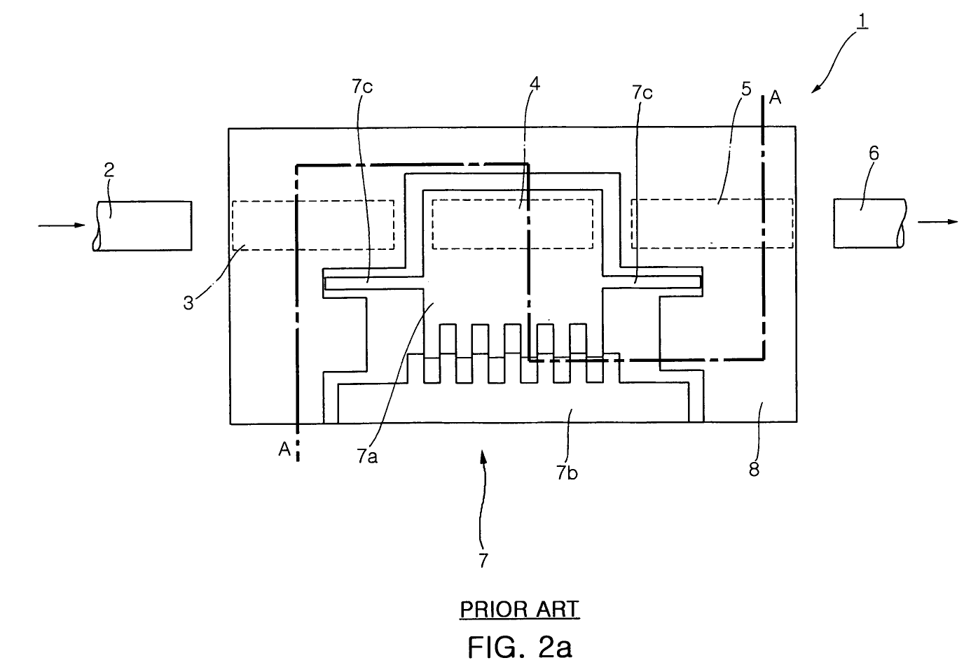

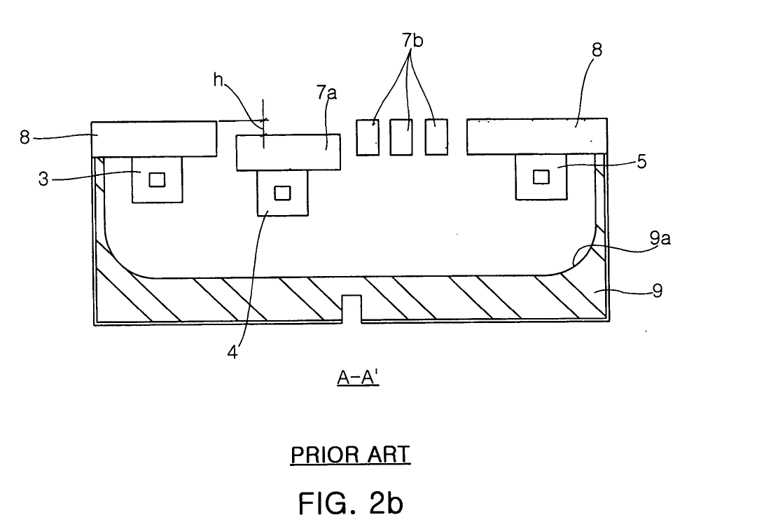

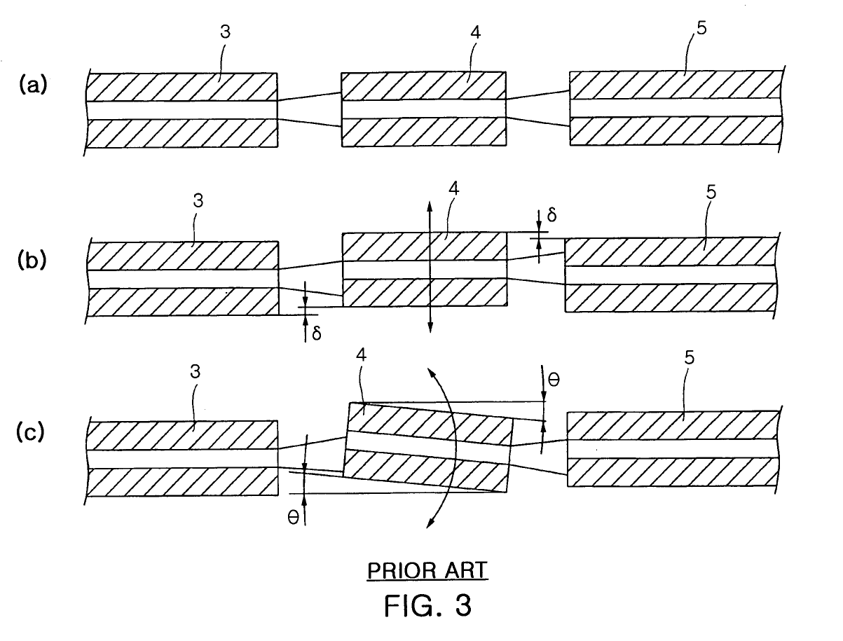

### DETAILED DESCRIPTION OF THE PREFERRED EMBODIMENT

A preferred embodiment of the present invention will now be described in detail with reference to the accompanying drawings.

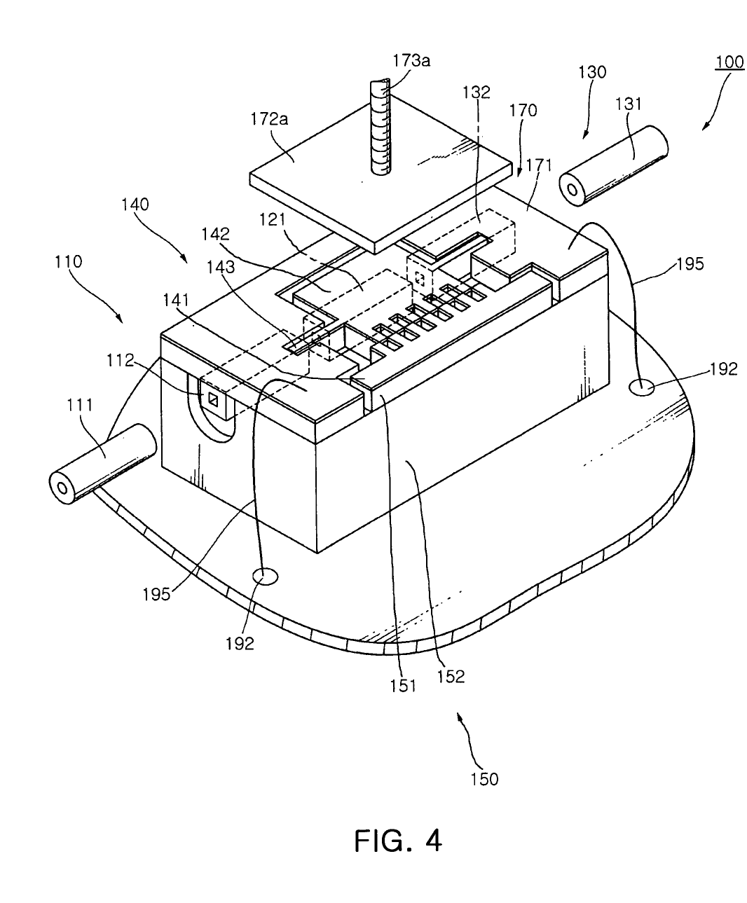

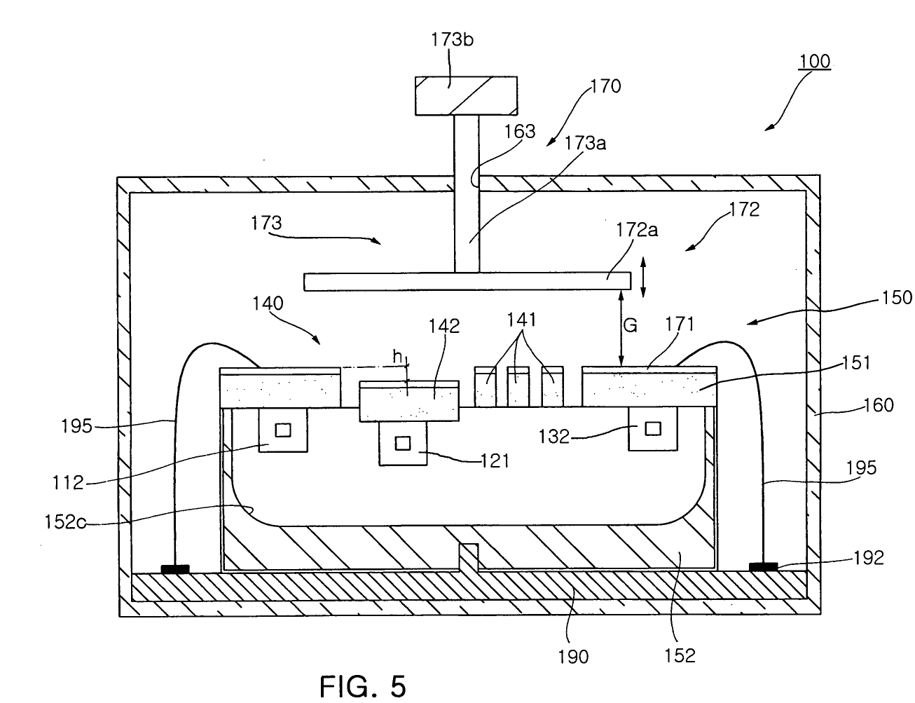

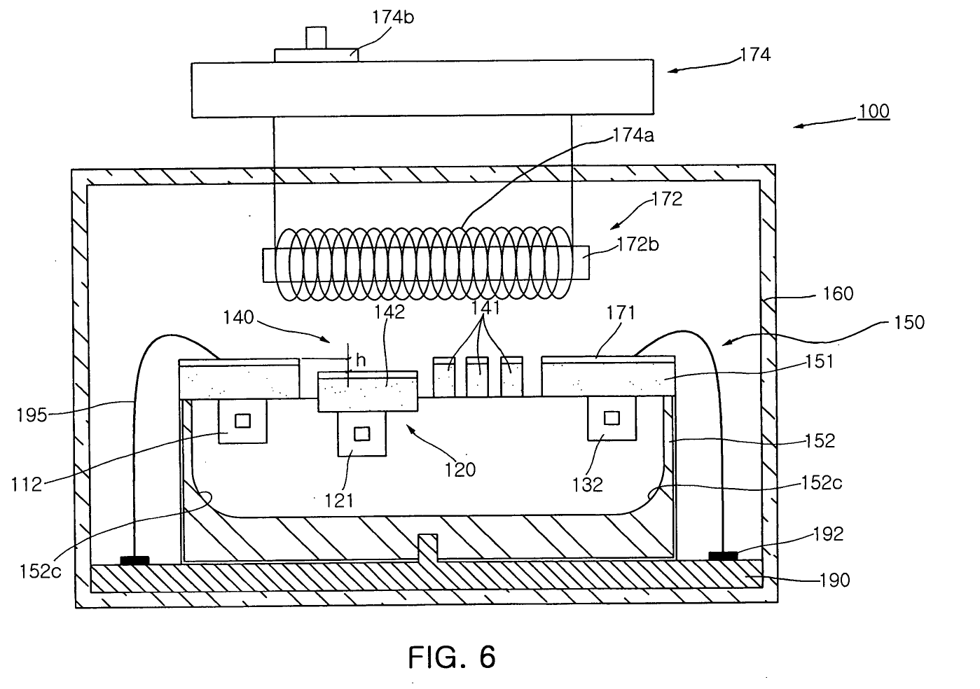

FIG. 4 is a perspective view of an optical attenuator according to a preferred embodiment of the invention, FIG. 5 is a sectional view illustrating the construction of the optical attenuator shown in FIG. 4, and FIG. 6 is a sectional view illustrating the construction of an optical attenuator according to an alternative embodiment of the invention.

An optical attenuator 100 of the invention, as shown in FIGS. 4 to 6, is contemplated on the basis that the latitudinal or vertical deformation causing the height difference between an attenuating waveguide and receiving and transmitting waveguides can be simply calibrated with magnetic force to minimize initial insertion loss. The optical attenuator 100 of the invention includes a receiving section 110, an attenuating section 120, a transmitting section 130, an actuator 140, an inner housing 150, an outer housing 160 and a calibrating section 170.

Describing it in more detail, the receiving section 110 includes a receiving optical fiber 111 for receiving light from a light source (not shown) and a receiving waveguide 112 mounted on a cover 151 of the inner housing 150 to guide incident light. It is necessary to coaxially align the receiving optical fiber 111 with the receiving waveguide 112 so that light can efficiently propagate along the receiving section 110 in one direction without insertion loss.

The transmitting section 130 includes a transmitting waveguide 132 mounted on the cover 151 of the inner housing 150 to guide light attenuated in the attenuating section 120 and a transmitting optical fiber 131 for emitting attenuated light. It is also necessary to coaxially align the transmitting waveguide 132 with the transmitting optical fiber 131 so that light can efficiently propagate along the transmitting section 130 in one direction without insertion loss.

The attenuating section 120 includes an attenuating waveguide 121 arranged between the receiving section 110 and the transmitting section 120 and mounted on a movable section 142 to attenuate light emitted from the receiving waveguide 111. The movable section 142 is movably connected to the cover 151 so that it can driven by the actuator 140.

The actuator 140 is actuating means which functions to shift the attenuating waveguide 121 arranged between the receiving waveguide 112 and the transmitting waveguide 132 across the propagation of light from the receiving optical fiber 111 to the transmitting optical fiber 131.

The actuator 140 includes a drive section 141 mounted on the cover 151 to be powered from an external power supply (not shown) and the movable section 142 connected to the cover 151 via movable stages 143 such as elastic members extended from the cover 151 so that the movable section 142 can be moved with respect to the drive section 141. The movable section 142 holds the attenuating waveguide 121 which is integrally mounted on the underside thereof.

When bias voltage is applied to the drive section 141 to shift back and forth the movable section 142 suspended via the movable stages 143 made of elastic members, the attenuating waveguide 121 mounted on the movable section 142 also moves back and forth across the propagation of light in response to the movement of the movable section 122 so as to attenuate the quantity of light or optical signals.

Herein the actuator 140 preferably comprises a comb drive type Micro Electro-Mechanical System (MEMS) having finger-shaped drive and movable sections, which drives the finger-shaped movable section across the propagation of light to attenuate light.

Also, the actuator 140 may drive the movable section 142 across the propagation of light via thermal actuation or piezoelectric actuation.

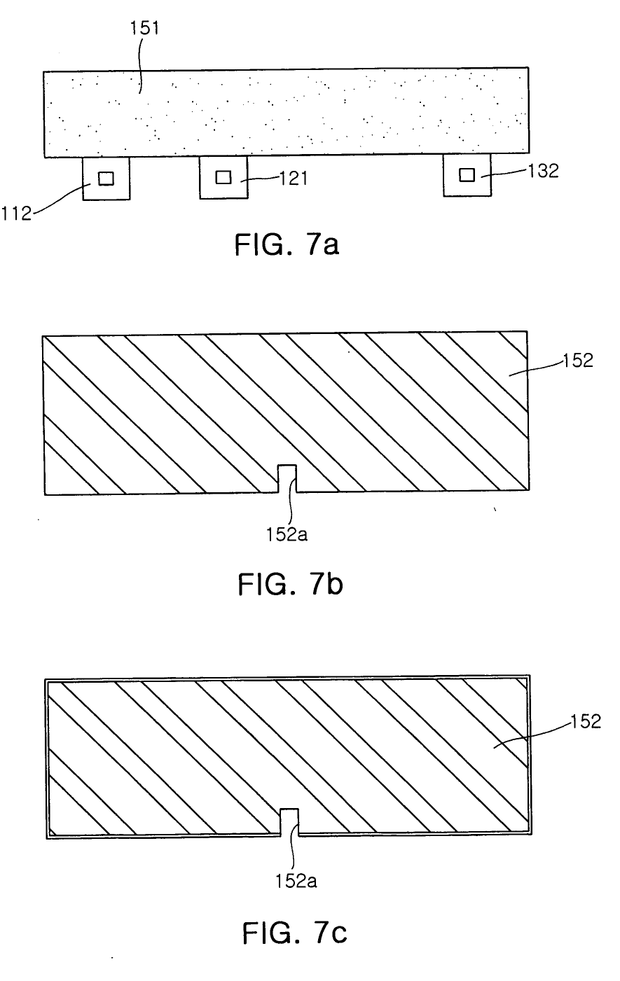

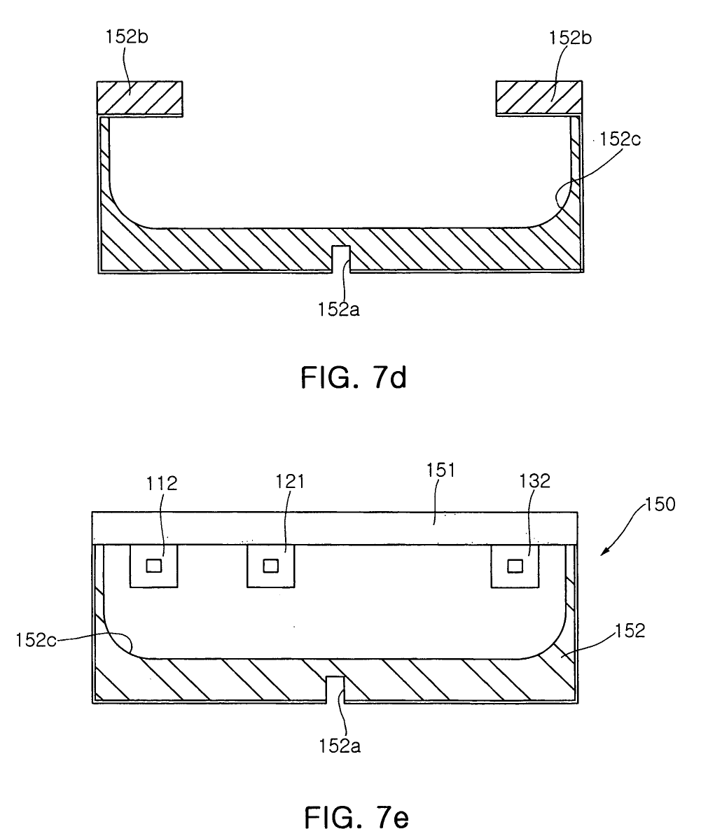

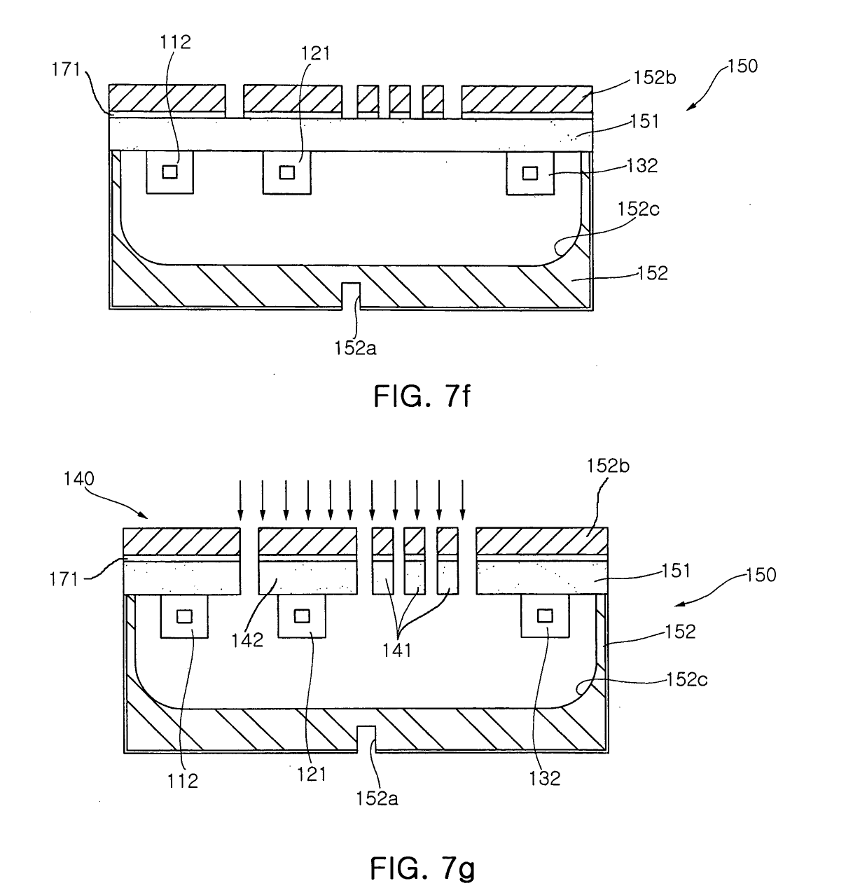

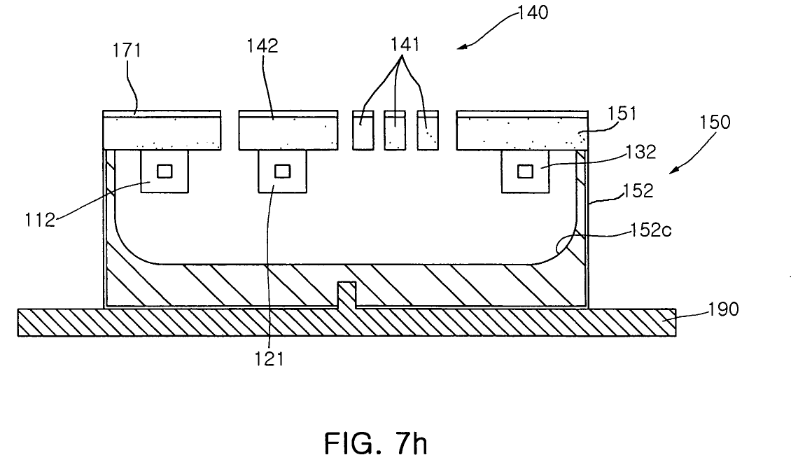

In the meantime, the inner housing 150 includes the cover 151 and a body 152 bonded with the cover 151. The cover 151 is made of a waveguide material such as silicon and polymer. On the underside of the cover 151, the receiving and transmitting waveguides 112 and 132 corresponding to the receiving and transmitting optical fibers 111 and 131 are coaxially aligned with the attenuating waveguide 121 as shown in FIG. 7A.

The body 152 is made of a glass wafer. As shown in FIGS. 7B and 7C, the body 152 has an alignment key 152a formed at the bottom so that the inner housing 150 can be correctly and efficiently assembled to a main board 190. Polyester is coated on the outside of the body 152 at a low temperature.

Then, as shown in FIGS. 7D and 7E, a photoresist 152b is coated on a first region (e.g., the periphery) of the upper face of the body 152, and the body 152 is wet-etched through a second region of the upper face without the photoresist 152b to a desirable depth to form a cavity 152c. Next the remaining photoresist 152b is removed from the body 152.

Where the receiving, transmitting and attenuating waveguides 112, 121 and 132 formed in the underside of the cover 151 are arranged within the cavity 152c without interference, the cover 151 and the body 152 are bonded together by bonding their interfaces. Next the cover 151 is ground at the upper face to reduce the thickness of the cover 151 in order to facilitate formation of the actuator 140 via etching.

In sequence, in order to form the drive section 141 and the movable section 142 of the actuator 140, a pattern of photoresist 152d is printed on the upper face of the cover 151 as shown in FIGS. 7F, 7G and 7H. Then, Inductively Coupled Plasma (ICP) is radiated from above onto the resultant structure to fabricate the actuator 140 having the drive section 141 and the movable section 142 mounted with the attenuating waveguide 121 in an upper region of the cover 151.

Then, the outer housing 160 is a protective member which is also mounted on the main board 190 to surround the inner housing 150, which is mounted on the main board 190, in order to protect the inner housing from external environment.

In the meantime, the calibration section 170 is arranged above the cover 151 to generate attractive force to pull the movable section 142 mounted with the attenuating waveguide 121 against the latitudinal deformation thereof so that optical axes of the attenuating section 120 and the receiving and transmitting sections 121 are constantly aligned coaxial with one another.

The calibration section 170 includes a thin metal layer 171 formed on the cover 151 and a magnetic member 172 supported by the outer housing 160 and generating magnetic force to pull the thin metal layer 171 upward.

Herein the thin metal layer 171 can be formed in the above fabrication process of the actuator 140 via etching by first coating a conductive pattern or layer on the upper face of the cover 151 and then printing the photoresist pattern 151d on the conductive layer.

The thin metal layer 171 is made of a ferromagnetic material such as Ni and NiFe so that it can sensitively react on the magnetic force of the magnetic member 172.

Further, since the thin metal film 171 is readily corrosive, the upper face of the thin metal film 171 is coated with a protective layer capable of minimizing oxidation of the thin metal film 171. The protective layer may be made of one selected from the group including Ti, Cr, Al and Au or a metal mixture thereof.

The thin metal layer 171 is also connected to output terminals 192 of the main board 190 mounted with the inner housing 150 via wire members 195 using a wire bonding technique in order to function as upper electrodes for supplying external power to the drive section 141 of the actuator 140.

In the meantime, as shown in FIG. 5, the magnetic member 172 may include a permanent magnet 172a which generates a uniform strength of magnetic force to an upper area of the cover 151 corresponding to the movable section 142 of the actuator 140.

In this circumstance, the permanent magnet 172a is designed to have a magnetic force of about 0.02 N regarding the maximum height difference h of about 20 μm owing to maximum deformation caused by the residual stress in the movable section 142.

Preferably, the optical attenuator of the invention further includes an adjusting section 173 for vertically shifting the permanent magnet 172a to vary a gap G between the cover 151 and the permanent magnet 172a. The adjusting section 173 includes a screw 173a with the permanent magnet 172a mounted on the leading end thereof and a control knob 173b arranged in the rear end of the screw 173a. The screw 173a is meshed into a tapped or threaded hole 163 of the outer housing 160 to achieve precise adjustment of the permanent magnet.

Then, the gap G between the cover 151 and the permanent magnet 172a is adjusted, i.e., decreased or increased according to the direction and magnitude of the rotation of the screw 173a for precision adjustment of the adjustment section 173 to vary the influence of the magnetic force for pulling the movable section 142 upward. Since the thin metal layer 171 is formed on the upper face of the movable section 142 mounted with the attenuating waveguide 121 on the underside, this can vary the position of the movable section 142 and thus the position of the attenuating waveguide 121.

Alternatively, as shown in FIG. 6, the magnetic member 172 may include an electromagnet 172b capable of varying magnetic force toward the upper area of the cover 151 corresponding to the movable section 142 of the actuator 140.

The electromagnet 172b includes a power supply 174 electrically connected with a wire 174a to be powered by the power supply 174. The power supply 174 also has a control knob 174b, by which the electric power to the wire 174a can be suitably adjusted to vary the strength of the magnetic force, i.e., an external force for compensating the vertical deformation of the movable section 142.

As a result, when the strength of electric power supplied to the wire 174a is increased or decreased by adjusting the control knob 174b of the power supply 174, the intensity of the magnetic force influencing to the upper area of the cover 151 is also varied to adjust the position of the movable section 142.

Alternatively, the calibrating section 170 may include a permanent magnet layer for generating a predetermined strength of magnetic force coated on the cover 151 at a predetermined thickness instead of instead of the thin metal layer 171 shown in FIG. 5. Then, the permanent magnet 172a supported by the outer housing 160 in FIG. 5 is also substituted by a metal member arranged above the permanent magnet layer to pull upward the movable section 142 mounted with the attenuating waveguide 121.

Preferably, the permanent magnet layer is pattern-printed on the upper face of the cover 151 at a predetermined thickness, and the metal member is made of a ferromagnetic material such as Ni and NiFe like the thin metal layer 171.

The outer face of the metal member is coated with a protective layer capable of preventing oxidation of the metal member within the outer housing 160. The protective layer is made of one selected from the group including Ti, Cr, Al and Au or a metal mixture thereof, and coated on the metal member via vapor deposition.

The permanent magnet layer coated on the cover 151 is connected with the output terminals 192 of the main board 190 via the wire members 195 using a wire bonding technique in order to function as upper electrodes for supplying external power to the drive section 141 of the actuator 140.

The metal member supported by the outer housing 160 includes an adjustment section 173 for shifting the metal member upward and downward to vary a gap G between the permanent magnet layer on the cover 151 and the metal member. The adjustment section 173 includes a predetermined length of precision-adjustment screw 173a meshed into a tapped or threaded hole 163 of the outer housing 160 and having the metal member mounted on the leading end thereof instead of the permanent magnet 172a and a control knob 173b arranged in the rear end of the screw 173a.

In the optical attenuator 100 of the invention having the above construction, when light is introduced into the receiving optical fiber 111 from a light source (not shown), incident light is attenuated by the attenuating section 120 arranged between the receiving and transmitting waveguides 112 and the 132 while propagating along the same.

When bias voltage is applied to the drive section 141 of the actuator 140 mounted on the cover 151, the attenuating waveguide 121 of the movable section 142, which is suspended from the cover 151 via the movable stages 143 such as elastic members, is offset axially or angularly across the propagation of light.

Because the movable section 142 is mounted with the attenuating waveguide 121 of the attenuating section 120 on the underside and suspended from the cover 151 via the movable section 141, it is vertically deformed and sags downward under the internal residual stress induced during fabrication of the actuator 140 such as forming the waveguides 112, 121 and 132 in the cover 151, grinding the cover 151 and bonding the cover 151 with the body 152, thereby causing insertion loss to attenuated light.

Thus, before attenuating light, an operator forcibly shifts the vertically deformed movable section 142 upward using the magnetic force of the magnetic member 172 within the outer housing 160 in order to coaxially align the receiving waveguide 112, the attenuating waveguide 121 and the transmitting waveguide 132.

Where the thin metal layer 171 made of a ferromagnetic material is coated on the upper face of the cover 151, the corresponding permanent magnet 172a of the magnetic member 172 is arranged right above the thin metal layer 171, and the adjustment section 173 is provided to adjust the vertical position of the permanent magnet 172a, the magnetic force of a predetermined strength from the permanent magnet 172a influences the thin metal layer 171 coated on the movable section 142 to pull upward the movable section 142 against the vertical deformation.

If the height difference between the drive section 141 and the movable section 152 becomes ‘zero’ as a result of the above process, the receiving and transmitting waveguides 112 and 132 of the cover 151 are alined coaxial with the attenuating waveguide 121 of the movable section 142 so that attenuation can be performed without insertion loss.

Further, because the gap G between the permanent magnet 172a and the thin metal layer 171 is increased or decreased by turning the precision-adjustment screw 173 meshed into the threaded hole 163 of the outer housing 160 in a forward or reverse direction, the upward displacement of the movable section 142 driven by the permanent magnet 172a can adjust the strength of the magnetic force applied to the thin metal layer 171 from the permanent magnet 172a for compensating the vertical deformation of the movable section 142 to the extent of placing the movable section 142 coplanar with the drive section 141.

Where the magnetic member 172 includes the electromagnet 172b powered from the power supply 174, the thin metal layer 171 is influenced by the electromagnetic force generated from the electromagnet 172b to pull the movable section 142 upward against the downward vertical deformation.

As the height difference h between the drive section 141 and the movable section 152 is ‘zero’, the receiving and transmitting waveguides 112 and 132 of the cover 151 are aligned coaxial with the attenuating waveguide 121 of the movable section 142 so that attenuation can be performed without insertion loss.

Further, because manipulating the control knob 174b of the power supply 174 can adjust the quantity of electric power supplied to the wire 17a wound around the electromagnet 172b to increase or decrease the electromagnetic force, the process of varying the position of the movable section 142 with the electromagnet 172b can also adjust the external force for pulling the movable section 142 upward to the extent of reducing the height difference to ‘zero.’

According to the present invention as set forth above, the magnetic force of the magnet member arranged right above the movable section can compensate or calibrate the vertical deformation of the movable section caused by the residual stress within the cover in order to reduce the height difference between the movable section and the drive section of the actuator as well as place the attenuating waveguide coaxial with the receiving and transmitting waveguides. As a result, the invention can remarkably improve optical properties of the optical attenuator while minimizing initial insertion loss.

Although the invention has been shown and described with reference to certain preferred embodiments thereof, it will be understood by those skilled in the art that various changes in form and details may be made therein without departing from the spirit and scope of the invention as defined by the appended claims.

1. An optical attenuator which includes an attenuating section arranged between a receiving waveguide coaxial with a receiving optical fiber and a transmitting waveguide coaxial with a transmitting optical fiber to attenuate the intensity of light emitted from the receiving waveguide to the transmitting waveguide, comprising:
an actuator for driving a movable section across the propagation of light, the attenuating section being arranged in the movable section;
an inner housing including a cover mounted with the receiving and transmitting waveguides in an underside thereof and a body arranged and bonded under the cover, the body having a cavity allowing the receiving and transmitting waveguides to be arranged without interference;
an outer housing containing and surrounding the inner housing to protect the same; and
a calibrating section for generating attractive force from above the cover to pull the movable section against the latitudinal deformation thereof so that optical axes of the attenuating section and the receiving and transmitting sections are coaxially aligned.

2. The optical attenuator according to claim 1, wherein the calibrating section includes a thin metal layer formed in an upper face of the cover and a magnet member supported by the outer housing to generate magnetic force for pulling the thin metal layer upward.

3. The optical attenuator according to claim 2, wherein the thin metal layer is a pattern printed on the upper face of the cover.

4. The optical attenuator according to claim 2, wherein the metal thin layer is made of a ferromagnetic material.

5. The optical attenuator according to claim 2, further comprising an anti-oxidation protective layer coated on the upper face of the thin metal layer.

6. The optical attenuator according to claim 5, wherein the protective layer is made of one selected from a group including Ti, Cr, Al, Au and mixtures thereof.

7. The optical attenuator according to claim 2, wherein the metal thin layer is an upper electrode connected with an output terminal of the main board via a wire member using a wire bonding technique.

8. The optical attenuator according to claim 2, wherein the magnet member is a permanent magnet for generating magnetic force toward the cover.

9. The optical attenuator according to claim 8, wherein the permanent magnet includes an adjustment section for shifting the permanent magnet upward or downward to vary the gap between the cover and the permanent magnet, and
wherein the adjustment section includes a predetermined length of a screw for precision adjustment, the screw being meshed into a threaded hole of the outer housing and mounted with the permanent magnet on a leading end thereof, and a control knob arranged in a rear end of the screw.

10. The optical attenuator according to claim 2, wherein the magnet member is an electromagnet capable of varying magnetic force to the cover.

11. The optical attenuator according to claim 10, wherein the electromagnet includes a power supply electrically connected with power-supplying wires, and
wherein the power supply has a control knob for adjusting the quantity of electric power supplied to the wire to vary the strength of magnetic force.

12. The optical attenuator according to claim 2, wherein the calibrating section includes a permanent magnet layer formed on the upper face of the cover to generate a predetermined strength of magnetic force and a metal member supported by the outer housing to pull the permanent magnet layer upward.

13. The optical attenuator according to claim 12, wherein the permanent magnet layer is a pattern printed on the upper face of the cover at a predetermined thickness.

14. The optical attenuator according to claim 12, wherein the metal member is made of a ferromagnetic material.

15. The optical attenuator according to claim 12, further comprising an anti-oxidation protective layer coated on the upper face of the thin metal layer.

16. The optical attenuator according to claim 15, wherein the protective layer is made of one selected from a group including Ti, Cr, Al, Au and mixtures thereof.

17. The optical attenuator according to claim 12, wherein the permanent magnet layer is an upper electrode connected with an output terminal of the main board via a wire member using a wire bonding technique.

18. The optical attenuator according to claim 12, wherein the metal member includes an adjustment section for shifting the metal member upward or downward to vary the gap between the permanent magnet layer and the permanent magnet, and
wherein the adjustment section includes a predetermined length of a screw for precision adjustment, the screw being meshed into a threaded hole of the outer housing and mounted with the metal member on a leading end thereof, and a control knob arranged in a rear end of the screw.
